(19) United States
(12) Patent Application Publication
(10) Pub. No.: US 2012/0056726 A1
(43) Pub. Date: Mar. 8, 2012

(54) Radio Controlled Step Dimmer Control for Fluorescent Light Fixtures

(76) Inventor: Jeffrey M. PAUL, Bel Air, MD (US)

(21) Appl. No.: 13/105,671

(22) Filed: May 11, 2011

Related U.S. Application Data
(60) Provisional application No. 61/333,699, filed on May 11, 2010.

(51) Int. Cl. G05B 11/01

(52) U.S. Cl. 340/12.5

(57) ABSTRACT

A lighting system includes a remotely controllable step dimmer for controlling one or more fluorescent light fixtures with a fixed or transportable light controller with a wireless signal transmitter and at least a first control input or switch configured for manual actuation by a lighting system user. The light controller transmitter is configured to wirelessly transmit one of a plurality of uniquely encoded or modulated lighting control signals to at least a first light fixture's wireless receiver.

This application claims the benefit of U.S. Provisional Application No. 61/333,699, Filed May 11, 2011, of Jeffrey M. Paul, the entire disclosure of which is incorporated herein by reference.

### BACKGROUND OF THE INVENTION

1. Field of the Invention

The present invention relates to control circuits for use with illumination sources such as fluorescent light fixtures, and more particularly to a programmable radio frequency transmitter to control a three-level, step-dimming ballast circuit configured for use with a fluorescent lighting fixture including fluorescent lamps, linear bulbs or tubes.

2. Discussion of the Prior Art

Fluorescent lighting has, in the past, been controlled by hard wired switches, where an on-off switch controls a ballast circuit in each light fixture which, in turn, energizes and controls one or more fluorescent light tubes. This method for controlling fluorescent lighting fixtures provided only on-off options for control, however, so a need arose for a method for regulating the light output, or brightness, of a fluorescent lamp, and in particular for regulating linear fluorescent lamps. This need was initially met by the development of a three-step dimming control wherein a fluorescent lamp was provided with a ballast that emulated the well-known multi-filament incandescent lamp and its three-step switching arrangement.

Switching provided two live inputs, and the ballast produced a high frequency and high voltage when both live inputs were connected, to produce a high lamp current, and a low frequency and low voltage lamp current when one of the two live inputs were connected, to produce a lower lamp current during dim level settings. Such systems have been unsatisfactory, however, for it has been difficult to achieve satisfactory preheat and ignition under low-voltage conditions.

The difficulties encountered in such designs were partially overcome in the prior art by the provision of a dimming florescent ballast utilizing an integrated circuit which provided closed loop regulation of the voltages supplied to the lamp to thereby achieve optimum preheat and ignition. However, such three-step dimmer ballasts still required a hard-wired three-way switch, which limits the usability of the dimmer control.

Accordingly, there is a need for an economical and easy to use remote controller for use with one or more dimmable fluorescent light fixtures. Such a controller would be particularly useful in large-scale commercial applications, but would be desirable for other applications, such as residential use, as well.

### OBJECTS AND SUMMARY OF THE INVENTION

It is, therefore, an object of the present invention to overcome the above mentioned difficulties by providing an economical, flexible and easy to install fluorescent lighting fixture control system.

It is another object of the present invention to provide an economical, flexible and easy to install remote control dimmer control for fluorescent lamps.

In accordance with the present invention, a simple to use lighting control system is provided for use with fluorescent lighting fixtures that are connected to a multi-level (e.g., three level) step dimming ballast circuit. Multi-level step dimming ballast circuits are well known to persons of skill in the art and are commercially available from many vendors such as General Electric, who sell, for example, the GE® LFL UltraMax™ Step Dimming Electronic Ballast #73231-GE332Max90-S60. Another example is the Sunpark Electronics Corp model U-2/32-3W-HBF step dimming ballast.

As will be explained in further detail below, in accordance with the method and apparatus of the present invention, a number of different configurations are provided to serve different operational purposes to permit easy control of florescent lamps to allow users to save on the amount of energy used in lighting and to lower energy costs for the user. These control circuits and methods are well suited to help meet new statutory requirements (e.g., California's Title 24, part 6) for energy efficiency.

The system of the present invention controls the light levels from a fluorescent light fixture remotely, without resort to wired control, utilizing a system with a programmable light control signal transmitter that generates radio signals that are received by a control signal receiver affixed near or included within the fluorescent light fixture and connected to operate a multi-level ballast in the fixture.

In one embodiment, suitable, for example, for installations configured to control one or more lamps in individual rooms, a light control transmitter is installed in a typical wall switch box. This light control transmitter is used to sense, detect or receive a user's control input and, in response, the light control transmitter is programmed or configured to generate and transmit a radio frequency (RF) light control signal to a remote receiver configured to receive the transmitted light control signal. In response, the receiver generates a lamp control signal which might include, for example, a pair of output control signals (e.g., output signal A and output signal B) which are supplied to a three-level step dimming ballast circuit included in the light fixture, to thereby control the on/off function and the level of the light emitted from one or more fluorescent lamps in the light fixture.

In summary, then, the present invention is directed to a lighting system incorporating a remotely controllable step dimmer for controlling one or more fluorescent light fixtures. The system includes at least one light fixture having a wireless receiver configured to receive and demodulate lighting control signals transmitted from a remotely located light controller and a light controller having a wireless signal transmitter and at least a first control input or switch configured for manual actuation by a lighting system user. The light controller transmitter is configured to wirelessly transmit a selectable one of a plurality of uniquely encoded or modulated lighting control signals to said at least one light fixture wireless receiver, and circuitry is provided in the wireless receiver for generating a light fixture ballast control signal in response to the demodulated lighting control signals.

The first light fixture also includes a first multi-level fluorescent lamp ballast configured to sense and respond to the light fixture ballast control signal and having first and second ballast outputs. The first light fixture also has a lamp socket adapted to receive at least one fluorescent lamp having first and second contacts, whereby the first contact is connected to the first ballast output and the second contact is connected to the second ballast output. When the light controller senses a user's actuation of the control input, it transmits a light control signal selected from the plurality of uniquely encoded or modulated lighting control signals, and the first fixture receiver controls the florescent lamp in response thereto.

The invention further includes a method for remotely controlling the luminous intensity generated by one or more fluorescent light fixtures, wherein at least one light fixture incorporates a wireless receiver configured to receive and demodulate lighting control signals transmitted from a remotely located light controller. The method includes providing, in the light controller, a wireless signal transmitter and at least a first control input configured for manual actuation by a lighting system user and incorporating in the transmitter circuitry for generating a plurality of uniquely encoded lighting control signals.

The method further includes configuring the light controller transmitter to wirelessly transmit a selected one of the plurality of uniquely encoded lighting control signals to the wireless receiver in the light fixture, receiving and demodulating in the wireless receiver the selected wirelessly transmitted lighting control signal, generating in the receiver a light fixture ballast control signal in response to the demodulated lighting control signals, providing in the first light fixture a first multi-level fluorescent lamp ballast configured to sense and respond to the light fixture ballast control signal and having first and second ballast outputs, and providing in the first light fixture a lamp socket adapted to receive at least one fluorescent lamp having first and second contacts.

When a lamp is connected in the fixture, the first lamp contact is connected to the first ballast output and the second lamp contact is connected to the second ballast output, so that when the light controller senses a user's actuation of the control input it transmits a light control signal selected from the plurality of uniquely encoded lighting control signals. The first fixture receiver then controls a florescent lamp connected in said lamp socket in response to the actuation of the lighting system controller by a user.

The method and apparatus of the present invention, including a programmable wireless radio frequency transmitter to control the three level step dimming ballast circuit in the lighting fixture, provides an effective and cost efficient method to conform with energy consumption regulations or laws such as California's Title 24, part 6.

### BRIEF DESCRIPTION OF DRAWINGS

The foregoing, and still further objects, features and advantages of the present invention will become apparent upon consideration of the following detailed description of a specific embodiment thereof, particularly when taken in conjunction with the accompanying drawings, wherein like reference numerals in the various figures are utilized to designate like components, wherein:

FIG. 1 is a block diagram of an RF system for controlling the dimming of a florescent lamp, in accordance with the present invention;

FIG. 2 is a rear elevation view of a remote control unit for the system of FIG. 1, suitable for installation in a conventional wall switch receptacle;

FIG. 3 is a side elevation view of the unit of FIG. 2;

FIG. 4 is a front elevation view of the unit of FIG. 2;

FIG. 5 is an exploded view of the unit of FIGS. 2-4;

FIG. 6 is a block diagram of the control circuit for the unit of FIGS. 2-4;

FIG. 7 is a perspective view of a dimmer receiver module for use in the system of FIG. 1;

FIG. 8 is an exploded view of the receiver module of FIG. 7;

FIGS. 9A, 9B, 9C, 10 and 11 illustrate alternative circuit diagrams for a portion of the module of FIGS. 7 and 8; and

FIG. 12 is a front elevation view of a control module incorporating an occupancy sensor, in accordance with the present invention.

### DESCRIPTION OF PREFERRED EMBODIMENTS

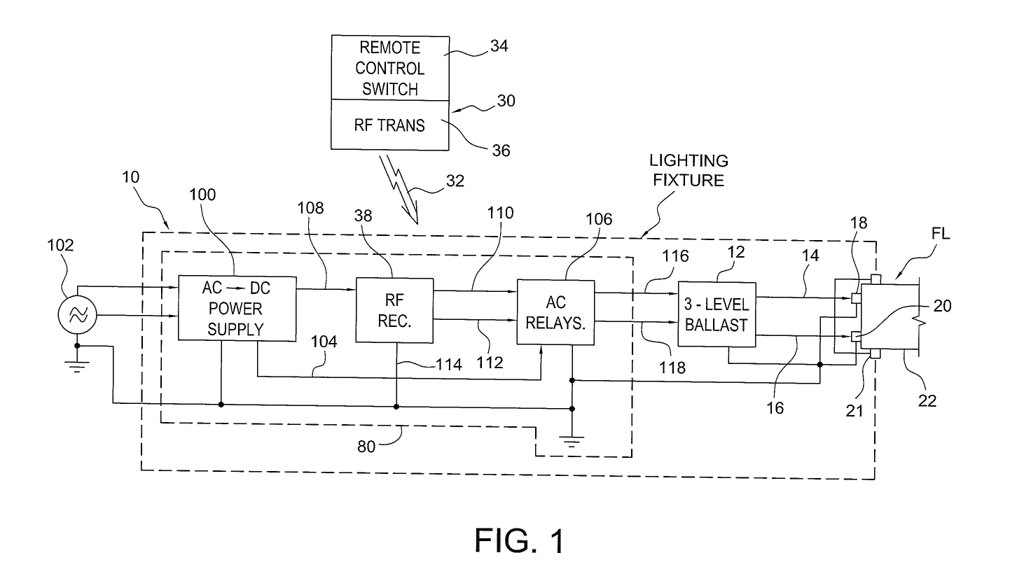

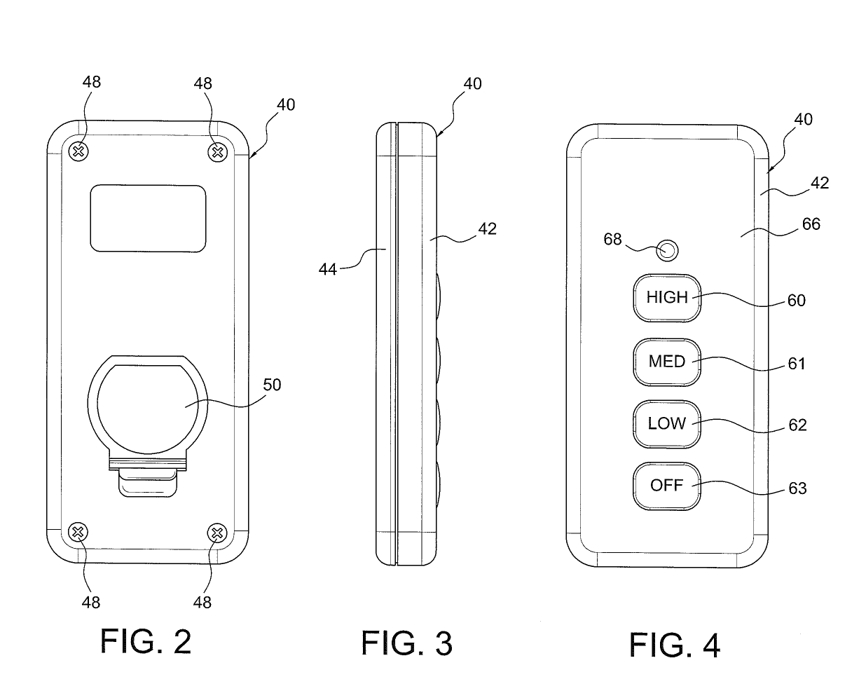

Turning now to a more detailed description of the present invention as illustrated in FIGS. 1-12, a controllable and dimmable florescent lighting fixture 10 is diagrammatically illustrated in FIG. 1 as including a commercially available multilevel florescent lamp ballast 12, in this embodiment a three-level ballast such as the GE® LFL UltraMax™ Step Dimming Electronic Ballast #73231-GE332Max90-S60 ballast available from General Electric, two outputs 14 and 16 of which are connected, in this case, to corresponding contacts 18 and 20, respectively, of a three-way florescent lamp 22 by way of a conventional three-way lamp socket diagrammatically illustrated at 21. Output voltages on either output 14 or 16, or both, control the illumination level of the fluorescent lamp, in known manner.

Although a single fluorescent lamp 22 is illustrated in FIG. 1, it is to be understood that the ballast may be connected to, and control, multiple lamps in a fixture 10, and that the fixture may be a ceiling light in a commercial or residential space. In accordance with the invention, the fixture 10, or if desired multiple such fixtures, are to be controlled through a remotely located, fixed or portable light controller 30 connected to the light fixture through a wireless link 32 that may be, for example, a 433 MHZ encoded RF signal. The controller 30 consists of a wall mounted or a portable control switch 34 connected to activate an RF transmitter 36, which communicates with a corresponding RF receiver 38 installed in the light fixture 10. Again, although a single lighting fixture is illustrated, it will be understood that multiple fixtures can be controlled by a single controller 30. A transmitter/receiver pair 36, 38, operates to provide several modes of operation for the fluorescent lights, not only controlling the on/off function but also energy saving modes for any fixture that receives the control signals, with the energy saving mode serving to dim the lamps in the fixtures by controlling the corresponding adjustable ballast.

The RF remote control switch and transmitter 30 is, in the embodiment of the invention illustrated in FIGS. 1-5, a wall mountable module 40 having a front housing segment, or faceplate 42, a back housing segment 44, and a printed circuit board 46 enclosed between the front and back housing segments and secured by suitable fasteners. A battery (not shown) is mounted on the back segment 44 and secured in place by a cover 50 that snaps in place on the back segment 44. The circuit board 46 carries multiple control switches, such as “high”, “medium”, “low” and “off” pushbutton switches 60-63, respectively, which are activated by a user through corresponding membranes on a panel overlay 66 that is secured to the face of housing segment 42. The switches are interconnected so that only one can be “on” at a time; pressing one pushbutton releasing all the others so that only one lighting level can be selected at a time. A red LED light 68 is designed into the faceplate to indicate when a transmission is in progress.

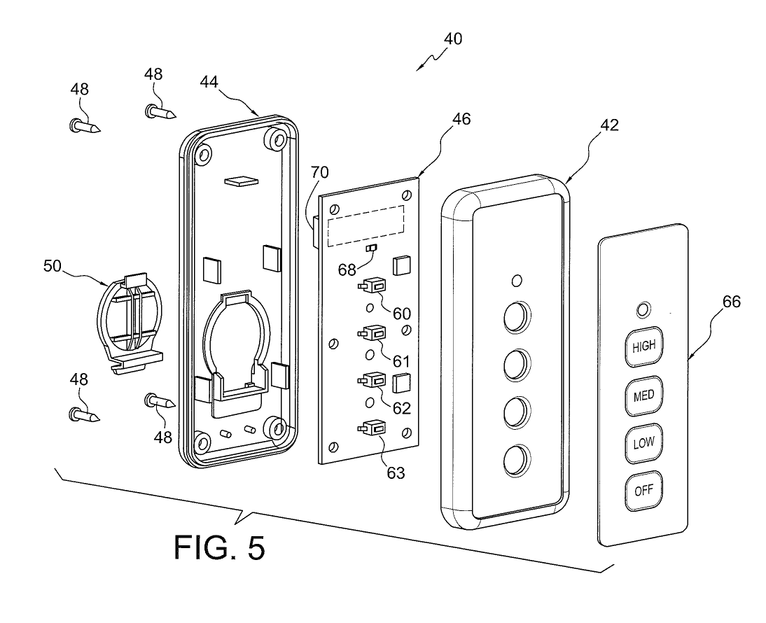

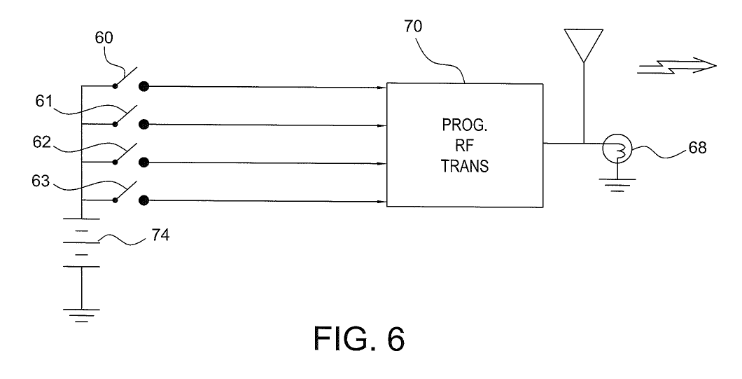

The switches 60-63 carried by the module 40 are illustrated in the diagram of FIG. 6 as being connected to corresponding inputs of a programmable RF transmitter 70 (indicated by dotted line 72 in FIG. 5) which corresponds to the Transmitter 36 of FIG. 1. The transmitter is mounted on the circuit board 46 and is connected to a battery 74 mounted in the module through the control switches 60-63, as illustrated. Each switch is connected to the RF transmitter to cause the transmitter to emit a corresponding encoded, or programmed, RF signal 32; for example, the RF signal may be pulse width or frequency modulated or otherwise encoded in known manner to send unique “high”, medium”, “low”, or “off” signals from the control module for reception by the corresponding receiver 38. The transmitter's DC power is provided by a battery instead of by an AC power line to enable the module 40 to either be mounted in a wall receptacle or to be portable. The transmitter hardware operates in a low power standby mode in order to conserve battery power. Only when a button is depressed on the faceplate does the transmitter hardware wake up and transmit the function code to the receiver. After a transmission it goes back into a sleep or standby mode.

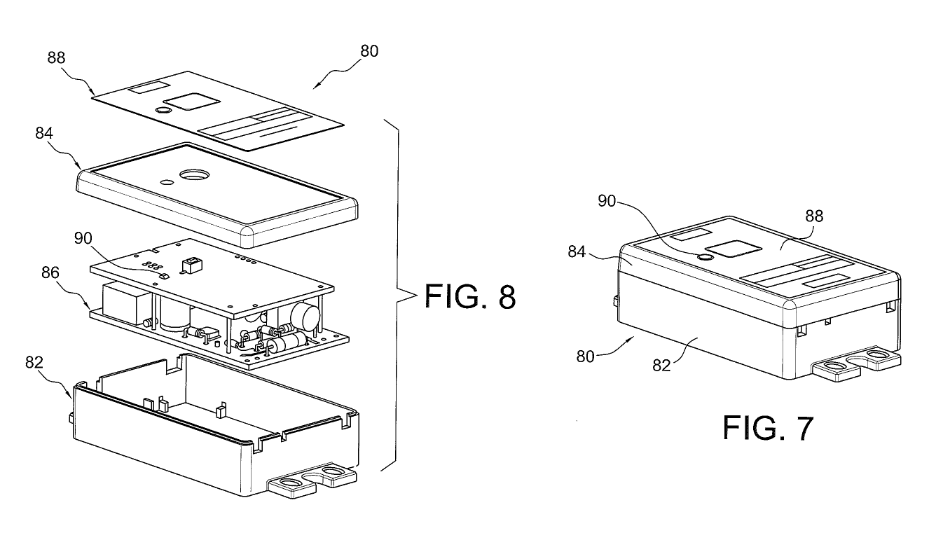

The encoded RF control signals 32 are detected by the RF receiver 38 which in the illustrated embodiment is incorporated in a receiver module 80 which is mounted in the lighting fixture 10; this module is illustrated diagrammatically in FIGS. 7 and 8 as including a bottom housing 82 and a top housing 84 enclosing a printed circuit board 86. A face cover 88 may be provided on the top housing and an indicator lamp 90, which may be a red LED, for example, may be provided to indicate reception of RF signals. An exemplary block diagram of the circuitry on module 80 is illustrated in FIG. 1, wherein an AC to DC power supply 100 is connected to an AC supply 102. The power supply 100 is mounted on the circuit board 86 in module 80, and furnishes AC power by way of line 104 to a series of AC relays 106, also on the circuit board 86, which in turn are activated to supply power to the three-level ballast 12 in the fixture 10 to energize the florescent lamp connected to a bulb socket 21 in the fixture 10.

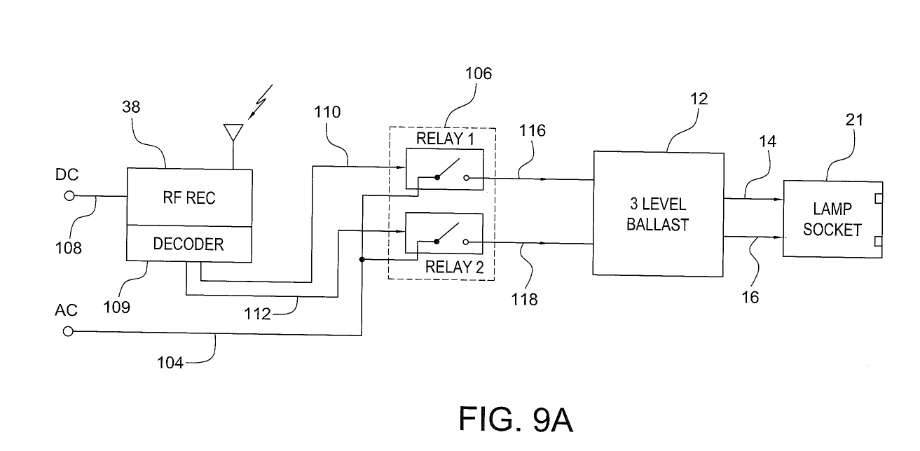

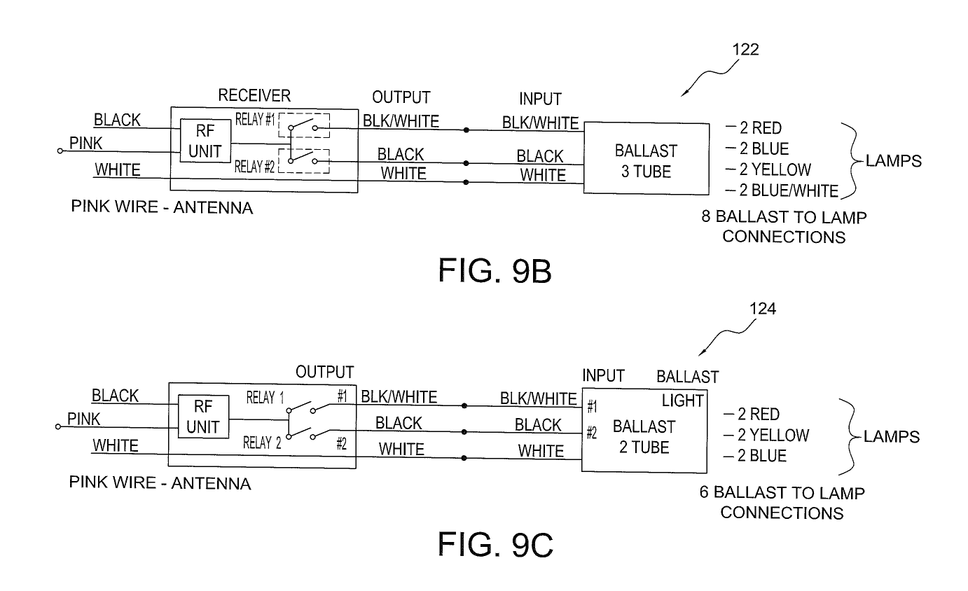

The power supply 100 also supplies DC power by way of line 108 to the RF receiver 38, which responds to the encoded RF signals 32 to decode the received signals at decoder 109, as illustrated in the example of FIG. 9A, and to produce control signals on output lines 110, and or 112 to activate relays 106. As illustrated diagrammatically in FIG. 9A, switches 106 are selectively activated by the decoded signals on lines 110 and 112 to produce AC supply voltages on lines 116 or 118 to activate the ballast 12 with a voltage on one or the other, or both of lines 110 and 112, as described above, to thereby illuminate the bulb to the desired level of brightness.

Alternative embodiments are illustrated in the schematic diagrams of FIGS. 9B and 9C. Comparing the alternative embodiments of FIGS. 9B and 9C with the embodiment of FIG. 9A, Relays 1 and 2 are connected differently. The relays are preferably solid state devices that are activated by the output from the RF receiver/decoder. FIGS. 9B and 9C show both switches being activated, where two distinct signals operate two distinct relays. For the 2 and 3 fluorescent lamp or tube ballasts, the ballast connections differ. There are eight (8) ballast connections for a 3 tube fixture 122 and six (6) ballast connections for a 2 tube fixture 124. Referring specifically to FIG. 9B, the diagram illustrates two separate relays with a common input to both, where two separate outputs are controlled by separate signals. FIG. 9C illustrates two tube fixture 124 having six (6) ballast to lamp connections.

It will be understood that each fluorescent light fixture will have a receiver module 80 connected between an AC power line and a single ballast or multiple ballasts. The receiver module has two AC input lines (120 or 277 VAC) which supply the AC-DC power supply and also supply AC to the ballast via the AC relays 106 which are activated in response to the two switch control signals indicated at 110 and 112 in FIGS. 1 and 9, produced by the receiver in response to received RF control signals. The two AC output lines 116 and 118 from the relays 106 in the module 80 control the ballast. In an example of a controller in accordance with the invention, the receiver was set to switch the ballast to a default setting of 40% (medium) whenever the AC power was initially applied to the module. Then, in order to switch the ballast to a 100% (high) or 10% (low) mode, the proper control button on the transmitter faceplate must be depressed. The LOW mode provided the lowest AC power consumption while dimming the lamp to 10% of its maximum setting. The medium mode provided a 40% AC power saving with a 40% light output, while the high mode provided 100% light output.

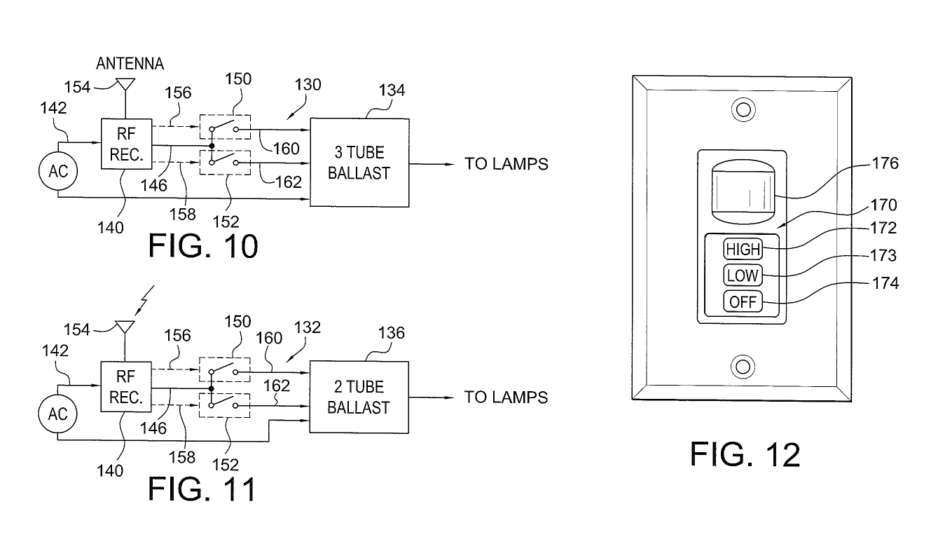

FIGS. 10 and 11 illustrate diagrammatically at 130 and 132 the control of 2-tube and 3-tube ballasts, 134 and 136, respectively. In the block diagram of FIG. 10, an RF receiver module receives AC power via line 142 and supplies that power via line 146 to a pair of controllable switches 150 and 152. Input RF control signals are received by the RF receiver 140 by way of antenna 154, are decoded as explained above, and are used to selectively activate switches 150 and 152, as indicated by dotted lines 156 and 158. Either one or both of the switches may be activated to supply AC power from line 146 through lines 160 or 162, or both, to the ballast 134. In the diagram of FIG. 11, in which similar components are similarly numbered, similar switches 150 and 152 are activatable by RF control signals to supply AC power through lines 160 and 162 to the ballast 136.

Each space to be lighted preferably will have its own wall mounted or portable transmitter, and the transmitter and receiver modules will be programmed with their own exclusive address codes. This prohibits a transmitter from activating not only its designated receiver, but receiver modules in nearby spaces. To assist in this, the transmitter should have a maximum range of about 100 feet.

If desired, the system of the present invention may employ an “occupancy sensor” wall mounted control module, or unit, such as that illustrated at 170 in FIG. 12. In the illustrated configuration, control module or unit 170 and its RF transmitter comprises a hardwired wall mounted module that may replace a regular AC—powered on/off mechanical switch for a lighting area. Such a unit may incorporate a transmitter faceplate having three buttons, illustrated at 172-174 to send selected encoded RF signals to the corresponding receiver to control the ballasts. The transmitter and its corresponding receiver cannot operate until AC power is switched ‘on’ by a motion detector 176 sensing movement in the designated space. The receiver, in response to the detection of motion, switches the ballast to a default setting of 40% light intensity whenever the AC power is initially applied to the receiver module. In order to switch the ballasts to a 100% or 10% mode, the proper button on the transmitter faceplate must be depressed. The low mode provides the lowest AC power consumption while dimming the controlled lamp or lamps to 10% of the maximum setting. The high mode provides 100% light output, in an exemplary mode of operation.

In operation of an example of the system of the present invention, when a selected one of the control inputs or buttons is pressed on the transmitter module 30 in FIG. 1, a corresponding unique RF data packet is transmitted.

The RF data packet may be comprised of the following:

8 Bit Sync+24 Bit Address+8 Bit Status(4)/cmd(4)+8 Bit CheckSum

MSBit of each byte is sent first. Byte send order is below

Sync (Bit7 . . . Bit0)→SYNC 1110.0111

RF Addr0 (Bit7 . . . Bit0)→ADR0(LSB)

RE Addr1 (Bit7 . . . Bit0)→ADR1(MID)

RF Addr2 (Bit7 . . . Bit0)→ADR2(MSB)

Command (Bit7 . . . Bit0)→CMD_BYTE (1010.0xxx) xxx are buttons

Chksum (Bit7 . . . Bit0)>CKSUM (sum of xor 0×55 of all bytes)

The RF receiver will receive the RF packet, demodulate, decode or decipher it and, as per the command bit, will turn ON two relays RLY1 and RLY2, which may be the two relays in block 106, to produce the indicated light level, as below:

| RLY1 | RLY2 | LIGHT LEVEL | |
|---|---|---|---|
| OFF | OFF | 0% | (OFF) |
| ON | OFF | 10% | (LOW) |
| OFF | ON | 40% | (MED) |
| ON | ON | 100% | (HIGH) |

For the transmitter, a 4 MHz internal oscillator may be used, for example, and for the receiver an 8 MHz internal oscillator may be used for the timing. The data packet duration in the illustration was 50 msec.

In another embodiment, the lighting system of the invention may also incorporate a daylight or ambient light sensor to sense ambient light and automatically reduce light levels in a building, when appropriate. This light sensor would be employed in a lighting control method typically used in large buildings with a significant source of outside light which can be “harvested” and put to productive use, supplementing the light generated by the light fixtures during the day.

Having described preferred embodiments of a new and improved circuit, apparatus and method, it is believed that other modifications, variations and changes will be suggested to those skilled in the art in view of the teachings set forth herein. It is therefore to be understood that all such variations, modifications and changes are believed to fall within the scope of the present invention.

What is claimed is:

1. A lighting system including a remotely controllable step dimmer for controlling one or more fluorescent light fixtures, comprising:
at least one light fixture including a wireless receiver configured to receive and demodulate lighting control signals transmitted from a remotely located light controller;
a light controller having a wireless signal transmitter and at least a first control input or switch configured for manual actuation by a lighting system user; said light controller transmitter being configured to wirelessly transmit a selectable one of a plurality of uniquely encoded or modulated lighting control signals to said at least one light fixture wireless receiver; and
circuitry in said wireless receiver for generating a light fixture ballast control signal in response to demodulated lighting control signals.

2. The lighting system of claim 1, wherein said at least one light fixture also includes a first multi-level fluorescent lamp ballast configured to sense and respond to said light fixture ballast control signal and having first and second ballast outputs;
said at least one light fixture having a lamp socket adapted to receive at least one fluorescent lamp having first and second contacts, whereby said first contact is connected to said first ballast output and said second contact is connected to said second ballast output; and
wherein said light controller senses a user's actuation of said control input and, in response, transmits light control signal selected from said plurality of uniquely encoded or modulated lighting control signals, and said receiver controls said first lamp in response thereto.

3. The lighting system of claim 2, wherein said control input for said light controller comprises multiple manually operable switches connected to said transmitter for selecting one of said plurality of uniquely encoded or modulated lighting control signals.

4. The lighting system of claim 3, wherein said transmitter is a radio frequency transmitter and said receiver is a wireless frequency receiver.

5. The lighting system of claim 4, wherein said circuitry in said wireless receiver for generating a light fixture ballast control signal in response to demodulated lighting control signals comprises relays connected to said receiver to produce selected first and second ballast outputs.

6. The lighting system of claim 5, wherein said fluorescent lamp is a fluorescent linear bulb or tube having first and second contacts.

7. A method for remotely controlling luminous intensity generated by one or more fluorescent light fixtures, comprising:
incorporating in at least one light fixture a wireless receiver configured to receive and demodulate lighting control signals transmitted from a remotely located light controller;
providing, in a light controller, a wireless signal transmitter and at least a first control input configured for manual actuation by a lighting system user;
incorporating in said transmitter circuitry for generating a plurality of uniquely encoded lighting control signals, and configuring said light controller transmitter to wirelessly transmit a selected one of said plurality of uniquely encoded lighting control signals to said wireless receiver in said at least one light fixture; and
receiving and demodulating in said wireless receiver said selected wirelessly transmitted lighting control signal.

8. The method for remotely controlling luminous intensity generated by one or more fluorescent light fixtures of claim 7, further comprising:
generating in said receiver a light fixture ballast control signal in response to said demodulated lighting control signals;
providing in said first light fixture a first multi-level fluorescent lamp ballast configured to sense and respond to said light fixture ballast control signal and having first and second ballast outputs;
providing in said first light fixture a lamp socket adapted to receive at least one fluorescent lamp having first and second contacts, whereby said first contact is connected to said first ballast output and said second contact is connected to said second ballast output;
sensing a user's actuation of said light controller's control input and, in response, transmitting a light control signal selected from said plurality of uniquely encoded lighting control signals, and
wherein said first fixture receiver controls a florescent lamp connected in said lamp socket in response to actuation of said lighting system controller by a user.

9. A remotely controllable light fixture including a step dimmer for controlling one or more step dimmable lamps, comprising:
a light fixture housing a wireless receiver configured to receive and demodulate lighting control signals transmitted from a remotely located light controller;
said light controller having a wireless signal transmitter and at least a first control input or switch configured for manual actuation by a lighting system user;
said light controller transmitter being configured to wirelessly transmit a selectable one of a plurality of uniquely encoded or modulated lighting control signals to said light fixture wireless receiver; and
circuitry in said wireless receiver for generating a light fixture control signal in response to demodulated lighting control signals.

10. The lighting system of claim 9, wherein said light fixture also includes a first multi-level fluorescent lamp ballast configured to sense and respond to said light fixture control signal by changing a first or second ballast outputs;
said at light fixture having a lamp socket adapted to receive at least one fluorescent lamp having first and second contacts, whereby said first contact is connected to said first ballast output and said second contact is connected to said second ballast output; and
wherein said light controller senses a user's actuation of said control input and, in response, transmits light control signal selected from said plurality of uniquely encoded or modulated lighting control signals, and said receiver controls said first lamp in response thereto.

11. The lighting system of claim 10, wherein said control input for said light controller comprises multiple manually operable switches connected to said transmitter for selecting one of said plurality of uniquely encoded or modulated lighting control signals.

12. The lighting system of claim 11, wherein said transmitter is a radio frequency transmitter and said receiver is a wireless frequency receiver.

13. The lighting system of claim 12, wherein said circuitry in said wireless receiver for generating a light fixture ballast control signal in response to demodulated lighting control signals comprises relays connected to said receiver to produce selected first and second ballast outputs.

14. The lighting system of claim 13, wherein said fluorescent lamp is a fluorescent linear bulb or tube having first and second contacts.
